(19) United States
(12) Patent Application Publication
(10) Pub. No.: US 2025/0225050 A1
(43) Pub. Date: Jul. 10, 2025

(54) TASK ALLOCATION APPARATUS AND TASK ALLOCATION METHOD

(71) Applicant: Mitsubishi Electric Corporation, Chiyoda-ku, Tokyo (JP)

(72) Inventors: Hiroki ITO, Tokyo (JP); Tetsushi MASUNO, Tokyo (JP); Kei WAKABAYASHI, Tokyo (JP)

(73) Assignee: Mitsubishi Electric Corporation, Chiyoda-ku, Tokyo (JP)

(21) Appl. No.: 18/698,962

(22) PCT Filed: Sep. 2, 2022
(86) PCT No.: PCT/JP2022/033065

§ 371 Date: Apr. 5, 2024

(30) Foreign Application Priority Data
Dec. 21, 2021 (JP) 2021-207056

(51) Int. Cl. G06F 11/34

(52) U.S. Cl. CPC G06F 11/3457; G06F 11/3433; G06F 11/3452

(57) ABSTRACT

An object of the present disclosure is to provide a task allocation apparatus capable of suppressing cost and deriving an efficient and optimal method of dividing a task. A task allocation apparatus according to the present disclosure includes: a simulation execution unit simulating a cooperation operation between at least a cloud server and an edge device; a metrics extraction unit extracting simulation environment metrics as an index for evaluating a non-functional requirement in the cooperation operation from an execution log as an execution result of the simulation execution unit; and a task allocation unit deriving at least one allocation of a task executing the cooperation operation based on the simulation environment metrics extracted by the metrics extraction unit.

### TECHNICAL FIELD

The present disclosure relates a task allocation apparatus and a task allocation method dividing a plurality of tasks included in one function and allocating them to a plurality of devices.

### BACKGROUND ART

Developed is a function of constituting Internet of Things (IoT) system (also simply referred to as “system” hereinafter) in which a cloud server (also simply referred to as “cloud” hereinafter) and an edge device such as a smartphone, for example, are connected and performing tasks and data cooperation therebetween, thereby providing a customer with a new additional value.

In development a cooperation function in the system, tasks necessary for achieving the function need to be appropriately allocated between the cloud and the edge device. A non-functional requirement for the cloud, the edge device, and communication between the cloud and edge device needs to be considered in allocating the tasks.

Examples of the non-functional requirement which needs to be considered include a central processing unit (CPU) load of the edge device, a communication amount generated between the cloud and the edge device, and a charging occurring in using the cloud. When a design of allocation of the tasks is failed, there is a possibility that a problem of stress of a CPU resource and excessive charging occur, and the design needs to be reworked.

The non-functional requirement is multifaceted, thus there is a difficulty in constituting a system in consideration of all of the non-functional requirements. A system to which a divided task is applied needs to be built, and each type of metrics obtained by executing the task in the system needs to be analyzed to confirm whether or not the system achieves the non-functional requirement, thus there is a problem that verification cost increases.

Accordingly, it is useful to reduce a period of time and cost of system design by automating a manual work required to constitute a system satisfying the non-functional requirement. For example, proposed is a method of automatically colleting a value of metrics corresponding to a non-functional requirement and optimizing the collected metrics to perform a system design (for example, refer to Patent Document 1 and Non-Patent Document 1).

Proposed in Patent Document 1 is a method of connecting an allocation apparatus to network between a cloud and an edge server to allocate a task between the cloud and the edge server and determining an allocation of the task with a mixed integer programming problem using load information of them as an input.

Proposed in Non-Patent Document 1 is a method of allocating a task with an NP-complete problem using a network band frequency and a memory amount between a cloud and an edge server as a limitation.

### PRIOR ART DOCUMENTS

### Patent Document(s)

Patent Document 1: International Publication No. 2020/004380 NON-PATENT DOCUMENT(S)
Non-Patent Document 1: Boyang Peng, et al. “R-Storm: Resource-Aware Scheduling in Storm”, Proceedings of the 16th Annual ACM Middleware Conference, Pages 149-161, Vancouver, BC, Canada, Dec. 7-11, 2015.

### SUMMARY

### Problem to be Solved by the Invention

As described above, required is efficient derivation of a design satisfying a non-functional requirement such as a CPU usage ratio, a network load, and charging by a cloud service, for example, by appropriately allocating tasks to devices constituting a system in installing a new function on a system. Proposed accordingly is a method of collecting a resource of a CPU usage ratio and a memory usage amount of each device and a communication amount between devices from a system by applying the divided tasks to the devices which are actually activated and optimizing the division of the tasks by analyzing a result thereof.

However, the system to be actually activated needs to be built using a public cloud and a real machine in the conventional method described above, and a deployment operation of a program on a cloud and an edge device, adjustment of procurance of a real machine, and security setting of a cloud, for example, need to be performed, thus there is a problem that cost of constituting environments increases.

Assumed in Patent Document 1 is a dynamic allocation using environments of a real machine, and a system including the real machine needs to be built to obtain an optimal allocation method, thus cost of constituting environment for executing verification increases.

Non-Patent Document 1 proposes an algorithm optimizing a method of allocating tasks with a plurality of devices, but does not mention problems such as a method of constituting a system and a method of obtaining a value of metrics.

The present disclosure is to solve such problems, and an object of the present disclosure is to provide a task allocation apparatus capable of suppressing cost and deriving an efficient and optimal method of dividing a task.

### Means to Solve the Problem

In order to solve the problems described above, a task allocation apparatus according to the present disclosure includes: a simulation execution unit simulating a cooperation operation between at least a cloud server and an edge device; a metrics extraction unit extracting simulation environment metrics as an index for evaluating a non-functional requirement in the cooperation operation from an execution log as an execution result of the simulation execution unit; and a task allocation unit deriving at least one allocation of a task executing the cooperation operation based on the simulation environment metrics extracted by the metrics extraction unit.

### Effects of the Invention

According to the present disclosure, cost can be suppressed, and an efficient and optimal method of allocating a task can be derived.

These and other objects, features, aspects and advantages of the present disclosure will become more apparent from the following detailed description when taken in conjunction with the accompanying drawings.

### BRIEF DESCRIPTION OF DRAWINGS

FIG. 1 is a block diagram illustrating an example of a configuration of a task allocation apparatus according to an embodiment 1.

FIG. 2 is a flow chart illustrating an example of an operation of the task allocation apparatus according to the embodiment 1.

FIG. 3 is a diagram illustrating an example of non-functional requirement metrics before conversion of each device according to the embodiment 1.

FIG. 4 is a diagram illustrating an example of the non-functional requirement metrics before conversion of network according to the embodiment 1.

FIG. 5 is a diagram illustrating an example of system specification information including specification information of each device according to the embodiment 1.

FIG. 6 is a diagram illustrating an example of system specification information regarding a usage unit price of a public cloud according to the embodiment 1.

FIG. 7 is a diagram illustrating an example of the non-functional requirement metrics after conversion of each device according to the embodiment 1.

FIG. 8 is a diagram illustrating an example of the non-functional requirement metrics after conversion of network according to the embodiment 1.

FIG. 9 is a diagram illustrating an example of system specification information regarding network according to the embodiment 1.

FIG. 10 is a diagram illustrating a display example of a task allocation result according to the embodiment 1.

FIG. 11 is a block diagram illustrating an example of a configuration of a task allocation apparatus according to an embodiment 2.

FIG. 12 is a diagram illustrating a display example of a task allocation result according to the embodiment 2. FIG. 13 is a diagram illustrating a display example of a task allocation result according to the embodiment 2.

FIG. 14 is a diagram illustrating an example of a configuration of network according to an embodiment 3.

FIG. 15 is a diagram illustrating an example of the configuration of the network according to the embodiment 3.

FIG. 16 is a diagram illustrating an example of a setting of a network limitation according to the embodiment 3.

FIG. 17 is a diagram illustrating a display example of a screen for comparing an optimization result for each network configuration according to the embodiment 3.

FIG. 18 is a diagram illustrating an example of a hardware configuration of the task allocation apparatus according to the embodiments 1 to 3.

FIG. 19 is a diagram illustrating an example of the hardware configuration of the task allocation apparatus according to the embodiments 1 to 3.

### DESCRIPTION OF EMBODIMENT(S)

### Embodiment 1

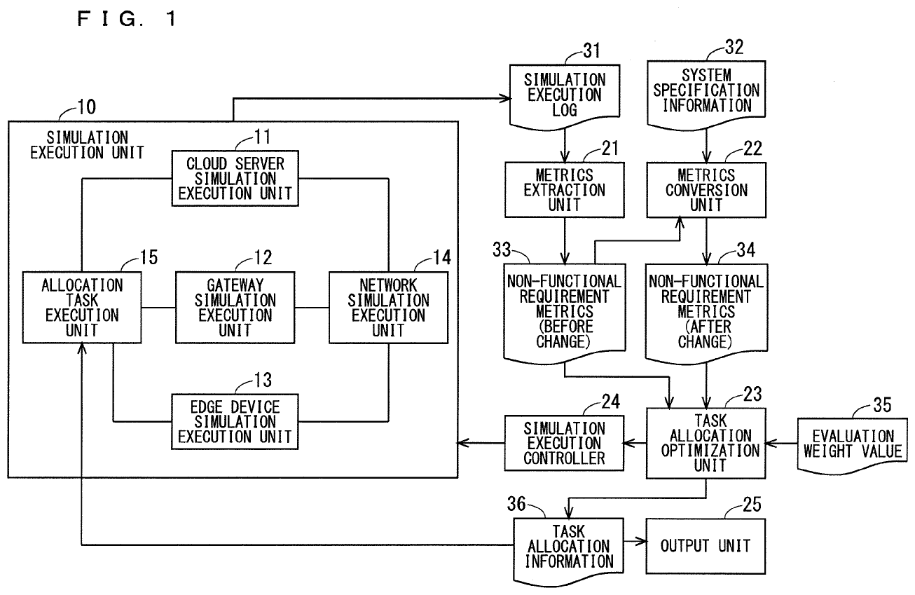

FIG. 1 is a block diagram illustrating an example of a configuration of a task allocation apparatus according to an embodiment 1.

The task allocation apparatus includes a simulation execution unit 10, a metrics extraction unit 21, a metrics conversion unit 22, a task allocation optimization unit 23, a simulation execution controller 24, and an output unit 25. The simulation execution unit 10 includes a cloud server simulation execution unit 11, a gateway simulation execution unit 12, an edge device simulation execution unit 13, a network simulation execution unit 14, and an allocation task execution unit 15.

The task allocation apparatus has a simulation execution log 31, system specification information 32, non-functional requirement metrics before conversion 33, a non-functional requirement metrics after conversion 34, an evaluation weight value 35, and task allocation information 36. Each information may be stored in a separate storage (not shown), or may also be collectively stored in one storage (not shown). The storage may be provided outside the task allocation apparatus.

In FIG. 1, the simulation execution unit 10 includes one cloud server simulation execution unit 11, one gateway simulation execution unit 12, and one edge device simulation execution unit 13, however, the configuration is not necessarily limited thereto illustrated in FIG. 1. For example, when a system to be simulated includes a plurality of edge devices, the simulation execution unit 10 may include the edge device simulation execution units 13 whose number corresponds the number of edge devices. In a system in which a cloud and an edge device are directly connected to each other with no gateway, a configuration eliminating the gateway simulation execution unit 12 is also be applicable. Furthermore, when a task on a side of a cloud is achieved by a plurality of instances, the simulation execution unit 10 may include the plurality of cloud server simulation execution units 11.

With regard to allocation information dividing a function which has been newly developed and allocating the function to each device (cloud, edge device, and gateway), a result optimized finally is stored as the task allocation information 36 in a storage.

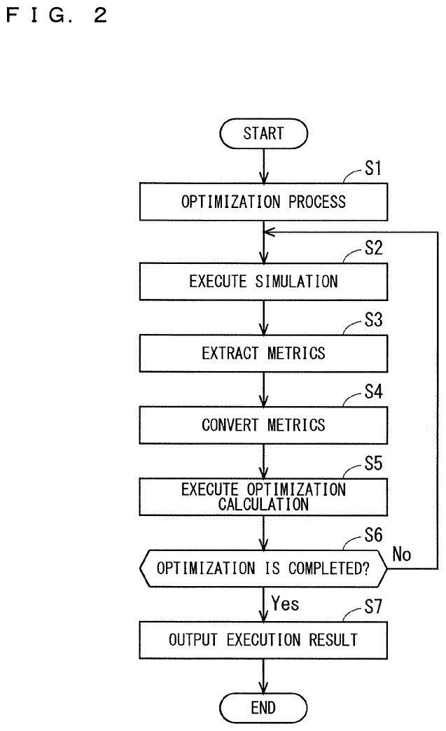

Herein, a method of deriving the task allocation information 36 is described using a flow chart in FIG. 2.

Derivation of the task allocation information 36 is achieved by executing an initialization process (Step S1), simulation execution (Step S2), metrics extraction (Step S3), metrics conversion (Step S4), and optimization calculation execution (Step S5). Details of each step are described hereinafter.

In the initialization process (Step S1), the task allocation apparatus initializes data before executing the initialization process. Firstly, execution conditions of a simulation are set for the simulation execution unit 10 and the cloud server simulation execution unit 11, the gateway simulation execution unit 12, the edge device simulation execution unit 13, and the network simulation execution unit 14 which constitute the simulation execution unit 10. Examples of the execution condition to be set include a setting of a type and a control parameter of an edge device to be simulated. An initial allocation of the task to each device is determined with regard to the task allocation information 36. A method of allocating the initial allocation is not particularly limited, but may be freely determined by a user.

In the simulation execution (Step S2), the simulation execution controller 24 activates and controls the simulation execution unit 10 so that the simulation execution unit 10 simulates a behavior in a simulation environment of network between the cloud, the gateway, the edge device, and each device. At that time, the allocation task execution unit 15 allocates the task divided in accordance with contents of the task allocation information 36 to each of the cloud server simulation execution unit 11, the gateway simulation execution unit 12, and the edge device simulation execution unit 13. Considered are a plurality of methods of achieving cooperation of the allocation task execution unit 15 with the cloud server simulation execution unit 11, the gateway simulation execution unit 12, and the edge device simulation execution unit 13. Examples of such methods include a method of executing a task by defining application programming interface (API) which can perform a task allocated to each device from outside and calling up the API at an optional timing of each of the cloud server simulation execution unit 11, the gateway simulation execution unit 12, and the edge device simulation execution unit 13. An execution result of the simulation is stored as the simulation execution log 31 in the storage.

In the metrics extraction (Step S3), the metrics extraction unit 21 extracts metrics from the simulation execution log 31. The simulation execution log 31 is data outputted from a command provided by an operating system (OS) or data outputted from a process for measurement added to a program, for example, and is analyzed to extract the metrics.

The extracted metrics serve as an index for mainly evaluating a non-functional requirement of a system, and is used for deriving the non-functional requirement metrics after conversion 34 used in the optimization calculation execution (Step S5) described hereinafter. Specifically, the metrics extraction unit 21 executes a process of extracting transition data of a CPU usage ratio from a monitoring log of a CPU resource and a process of extracting a size of a payload used for communication from a communication log. The extracted metrics are stored as non-functional requirement metrics before conversion 33 in the storage.

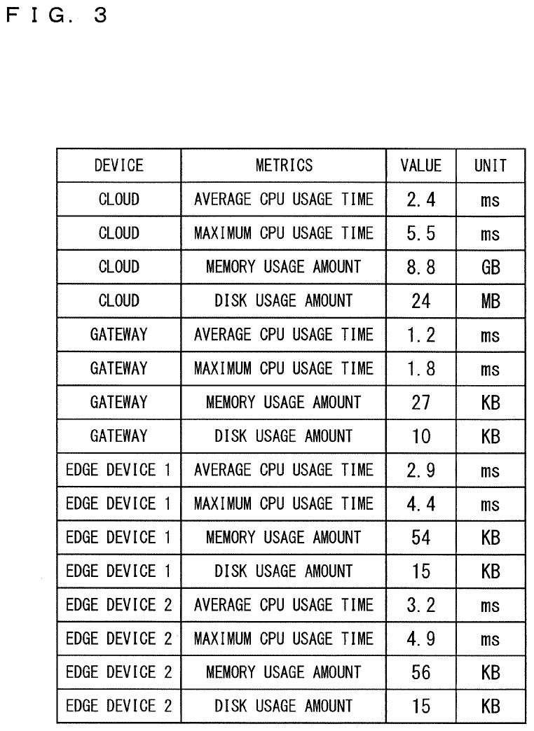

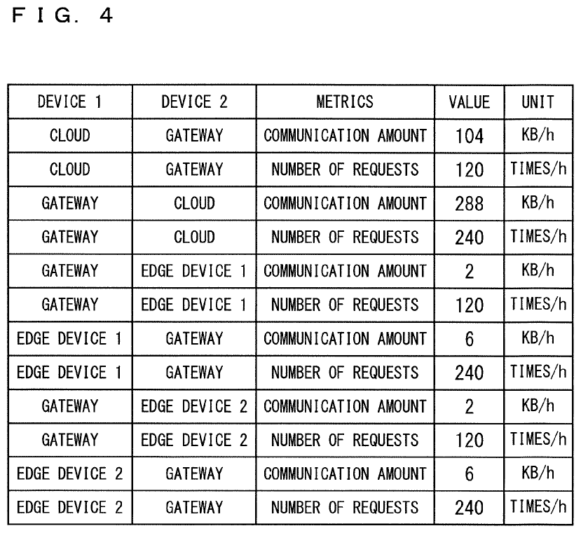

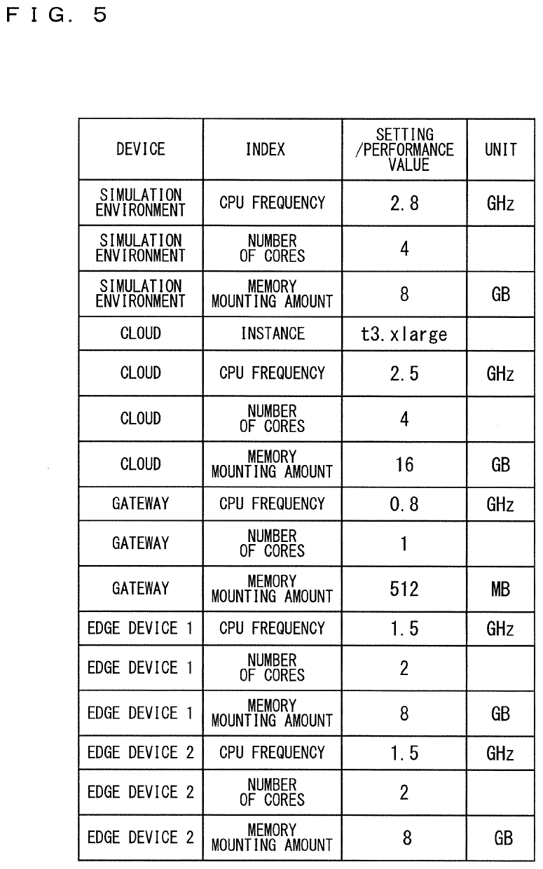

FIG. 3 illustrates an example of items of non-functional requirement metrics before conversion 33 stored by the process of metrics extraction (Step S3). As illustrated in FIG. 3, the items of the metrics with regard to each device include a CPU usage time (an average CPU usage time and a maximum CPU usage time) by executing the task, a memory usage amount, and a disk usage amount, for example. FIG. 4 illustrates an example of the items of the metrics with regard to the communication between the devices. As illustrated in FIG. 4, the items include a communication amount indicating a communication data amount and the number of requests indicating the number of requests. The items illustrated in FIG. 3 and FIG. 4 are examples, thus a type of extracted metrics can be added or deleted to improve contents and accuracy of optimization.

In the metrics conversion (Step S4), the metrics conversion unit 22 converts a value of the metrics corresponding to the simulation environment into a value of the metrics assumed in a real environment operation using the system specification information 32 and non-functional requirement metrics before conversion 33, and stores the value thereof as the non-functional requirement metrics after conversion 34 in the storage.

A specification of a constituent device and network performance between devices are different between the simulation environment and the real environment. For example, a CPU specification of each device is different in the real environment, and a microcomputer having relatively low performance is used in the edge device in some cases. In the meanwhile, a device is operated with basically the same specification on a general-purpose personal computer (PC) in the simulation environment. Various methods such as Ethernet (registered trademark) or Wi-Fi (registered trademark) are considered as the communication between the devices in the real environment, however, the communication in the simulation environment is communication in a general-purpose PC. A correction calculation in consideration of a difference of performance by such a real environment is performed in the metrics conversion (Step S4) to derive an assumed value in the real environment.

Described is an example of implementing the correction calculation in the process of metrics conversion (Step S4). FIG. 5 is a diagram illustrating an example of the system specification information 32. The specification information included in the system specification information 32 is targeted to the simulation environment executing the simulation and the device operated in the real environment. An item of the specification information is a CPU frequency, the number of cores of CPU, and a memory mounting amount, for example. In a case of the cloud, a type of a virtual machine to be operated (for example, t3.xlarge instance in EC2 of amazon web service (AWS), for example) is described in some cases. The items illustrated in FIG. 5 are examples, thus can be added or deleted to improve contents and accuracy of optimization.

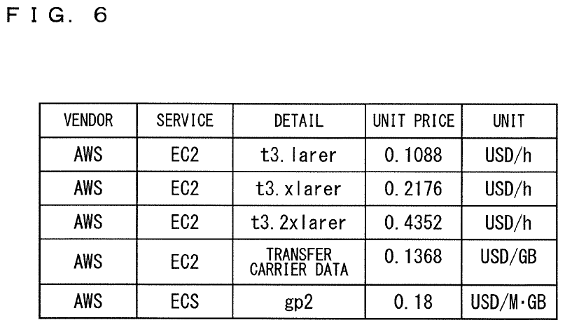

The item of evaluating the task allocation can include charging by the cloud. A payment structure of a target public cloud may be inputted to be included in the system specification information 32. In this case, a usage unit price for service of the public cloud illustrated in FIG. 6 can be used, and an assumed charging value can be derived from the obtained non-functional requirement metrics before conversion 33.

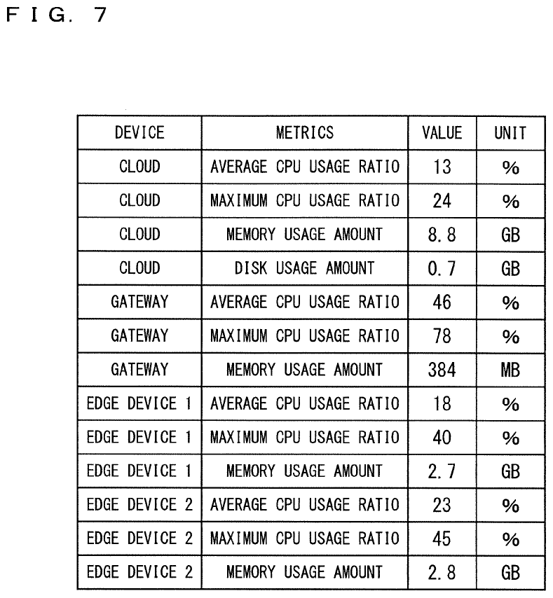

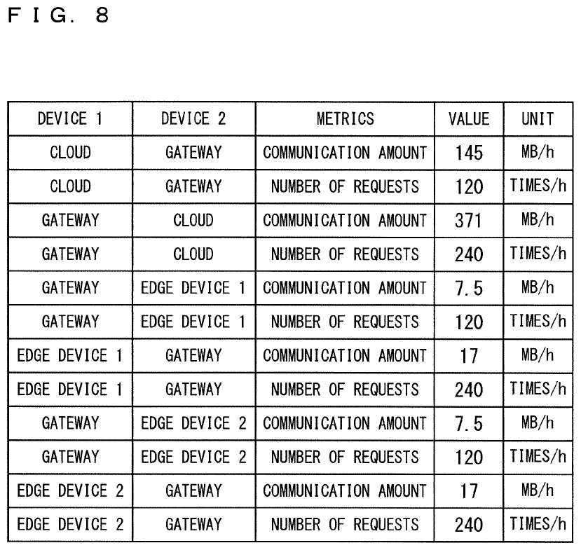

In the metrics conversion (Step S4), the metrics conversion unit 22 implements the correction calculation based on a value defined in the system specification information 32 on the non-functional requirement metrics before conversion 33. FIGS. 7 and 8 illustrate an example of a value of the non-functional requirement metrics after conversion 34. For example, an assumed value of an average CPU usage ratio in an edge device 1 can be calculated by two correction processes. Firstly, an average CPU usage time is multiplied by a ratio of a CPU specification using the average CPU usage time in the simulation environment as an input to derive an average CPU usage time in the edge device 1 assumed in the real environment operation. Next, the average CPU usage ratio converted from the derived average CPU usage time and an average CPU usage ratio by a task other than the allocation task (task other than the non-functional requirement) are combined to derive an average CPU usage ratio by the edge device 1. When an original average CPU usage ratio in the edge device 1 is 15%, an assumed value of the average CPU usage ratio of the edge device 1 after integrating the allocated task can be calculated as the following Expression (1)

$$( 2.9 \times 10 \div 1000 ) + 0.15 = 0.03 + 0.15 = 0.18 = 18 [ \% ] \qquad ( 1 )$$

In the optimization calculation execution (Step S5), the task allocation optimization unit 23 evaluates validity of a current task allocation using the non-functional requirement metrics before conversion 33, the non-functional requirement metrics after conversion 34, and the evaluation weight value 35 as an input to store an optimal task allocation result derived by the calculation as the task allocation information 36 in the storage. The task allocation optimization unit 23 performs the optimization calculation and derives the allocation result, however, a specific optimization algorithm needs to be used. An optional algorithm may be applied in accordance with the number of types of metrics and characteristics of the evaluation method.

A user sets the evaluation weight value 35 in accordance with importance of the evaluation item. For example, when there is high importance of a task load, a weight value of metrics of the CPU usage ratio is set high. At that time, applicable is a method of previously defining a set of a weight value corresponding to evaluation contents as a category without designating the weight as an immediate value and selecting the category by the user.

For example, in a case where the non-functional requirement is lower than a required value (non-functional requirement does not satisfy the required value) is detected and the evaluation is performed, considered is a method of adding a penalty term of an evaluation function when the value of the metrics is worse than the required value, thereby feeding back to the optimization algorithm. For example, the following Expression (2) is considered as a simple evaluation function providing a penalty when a value of an optional evaluation metrics exceeds a threshold value. Herein, xₙ is a variable serving as a flag in which 1 is outputted when the value of the metrics is worse than the threshold value, and mₙ is a weight coefficient expressing a penalty value in a case where a value of n^{th} metrics is worse.

$$F ( x ) = {m}_{1} {x}_{1} + {m}_{2} {x}_{2} + … + {m}_{n} {x}_{n} \qquad ( 2 )$$

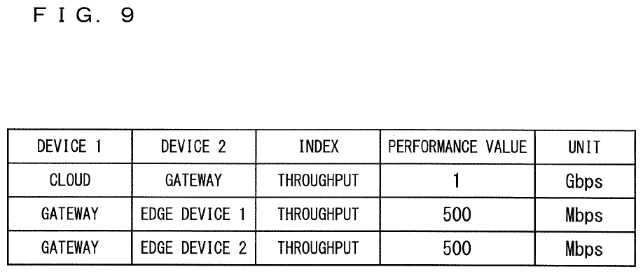

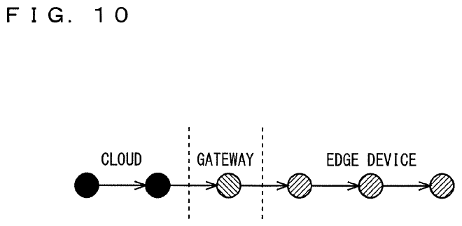

For example, a communication amount per unit time is calculated in the non-functional requirement metrics after conversion 34, and the flag is established when the value thereof exceeds an upper limit value of a throughput of the network in the real environment as illustrated in FIG. 9, thus the throughput of the network can be included in a target of an appropriateness evaluation to be allocated.

The evaluation function described above is an example, thus it is applicable that a value of the variable is not discretely determined by the threshold value, but a difference from a target value is treated as a continuous variable, or an evaluation index made of a combination of values of the plurality of metrics is introduced to define the evaluation variable.

In Step S6, the task allocation optimization unit 23 determines whether or not the task allocation information 36 converges to the optimization calculation. When the optimization calculation of the task allocation is not converged, the simulation execution unit 10 executes the simulation again (simulation execution in Step S2) using the task allocation information 36 derived by the task allocation optimization unit 23 as a new allocation. At this time, the task allocation information 36 is inputted to the allocation task execution unit 15, and the cloud server simulation execution unit 11, the gateway simulation execution unit 12, the edge device simulation execution unit 13, and the network simulation execution unit 14 in the simulation execution unit 10 execute the task by control of the simulation execution controller 24.

Subsequently, a process equivalent to the procedure described above is performed to evaluate validity of the new allocation. Such a procedure is repetitively executed to derive the optimal task allocation by the optimization calculation.

When optimization calculation performed by the task allocation optimization unit 23 is completed in Step S6, an execution result output (Step S7) is implemented.

In the execution result output (Step S7), the output unit 25 notifies a user of contents of the task allocation information 36 derived as the optimization result. The output unit 25 displays an optimal task allocation result in a graphical form on a monitor, for example.

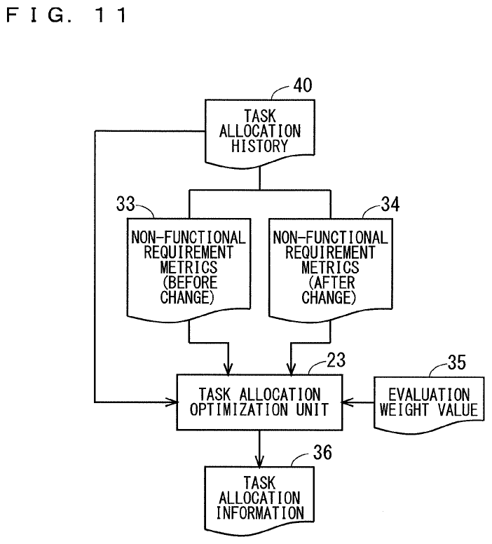

For example, it is applicable that the output unit 25 displays the allocation result of the task as a graph structure as illustrated in FIG. 10 and sections a region of the tasks allocated to the cloud, the gateway, and the edge device, thereby proposing an interface of the allocation of the task to the user. Adoptable is an optional method of not only display on a monitor but also output to a file as a method of notifying the user.

As described above, according to the embodiment 1, an optimal method of allocating a task achieving a function newly developed in each device constituting a system at a time of applying the function newly developed to the system can be derived without constituting the system which is actually activated. Accordingly, cost can be suppressed, and an efficient and optimal method of dividing a task can be derived.

### Embodiment 2

The optimization of the task allocation described in the embodiment 1 indicates derivation of single optimal allocation information basically using a single evaluation function and evaluation weight value. However, also considered depending on a case of usage is a case where the optimization result by the single evaluation method is not adopted as it is but applied is method of setting a plurality of evaluation methods to implement the optimization, and selecting an appropriate allocation method from each optimization result.

For example, when charging in the cloud is considered, considered are a viewpoint of deriving the allocation by the evaluation method of suppressing a charging amount as much as possible and a viewpoint of deriving the allocation by the evaluation method of emphasizing performance while allowing charging to some extent. According to the above method, a user can confirm the allocation result in both the viewpoints, and can adopt one of them after determining whether or not the user can allow increase of the charging amount.

In order to achieve the case of usage described above, considered as a simple method is a method of multiplexing the units other than the task allocation optimization unit 23 to corresponding to each evaluation function to execute the optimization calculation and the simulation for each evaluation function. According to this method, the optimization calculation can be independently implemented on each evaluation function, however, there is a weak point that a calculation time increases.

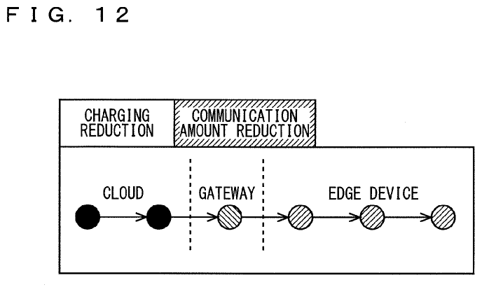

A devisal of communalizing some of the processes executed in the optimization calculation for reducing a redundant calculation is necessary to reduce the calculation time of the optimization calculation. For example, as illustrated in FIG. 11, when the simulation needs to be executed in the same condition for each evaluation function in the task of executing the optimization calculation, the non-functional requirement metrics before conversion 33 and the non-functional requirement metrics after conversion 34 corresponding to the simulation result which has been previously executed are held to map (correspond) to a task allocation history 40, and the task allocation optimization unit 23 refers to these contents, thus the repetitive execution of the simulation can be reduced to increase a speed of the optimization calculation. The configuration other than the configuration illustrated in FIG. 11 is similar to that of the task allocation apparatus illustrated in FIG. 1.

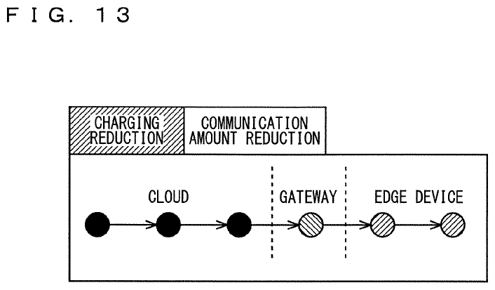

When the optimization calculation according to the present embodiment 2 is executed, the task allocation result for each evaluation function is stored as the task allocation information 36 in the storage. The output unit 25 notifies a user of the optimization result for each evaluation function included in the task allocation information 36. For example, the output unit 25 may divide the allocation result for each evaluation contents and displays the divided allocation result on a monitor in a graphical form as illustrated in FIGS. 12 and 13. Adoptable is an optional method of not only the method described above but also output to a file as a method of notifying the user.

As described above, according to the embodiment 2, when the simulation needs to be executed in the same condition for each evaluation function, some of the processes executed in the optimization calculation is communalized, thus the redundant calculation can be reduced. The user can be notified of the task allocation result for each evaluation function.

### Embodiment 3

In the embodiment 1, the network simulation execution unit 14 has a duty of simulating communication executed between any of the cloud server simulation execution unit 11, the gateway simulation execution unit 12, and the edge device simulation execution unit 13. The communication executed via the network simulation execution unit 14 is monitored by the metrics extraction unit 21, and a communication amount thereof, for example, is measured.

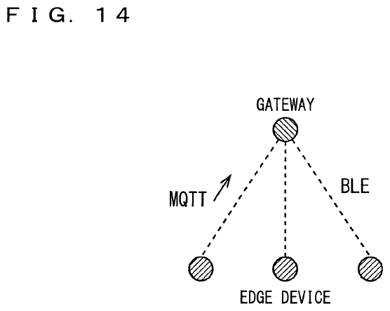

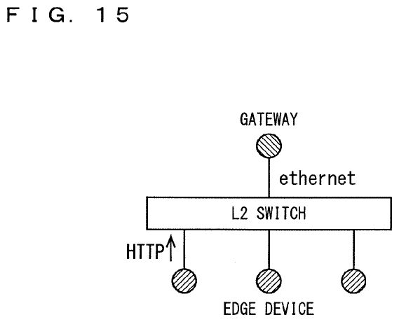

Various patterns are considered as a connection system between the devices as illustrated in FIGS. 14 and 15. For example, when wireless communication is assumed, Bluetooth low energy (BLE) is considered to be adopted in consideration of electrical power saving. When wired high-speed communication is assumed, considered is a configuration of inserting a switch between the gateway and the edge device to connect them by Ethernet (registered trademark). In the configuration of inserting the switch between the gateway and the edge device, communication performance is deteriorated when communication which is transmitted and received exceeds a process capacity of the switch, review of the configuration needs to be considered in such a case.

The communication amount is changed depending on a communication protocol to be selected. Even in a case of communicating the same data, a total communication amount is changed depending on a difference of a data size of a header part added by the selected communication protocol, for example. For example, a header size is equal to or larger than 50 bytes in a hypertext transfer protocol (HTTP) used in communication with the web, and in contrast, a header size of a message queue telemetry transport (MQTT) is equal to or larger than 2 bytes, thus the total communication amount is smaller in transmitting data by the MQTT.

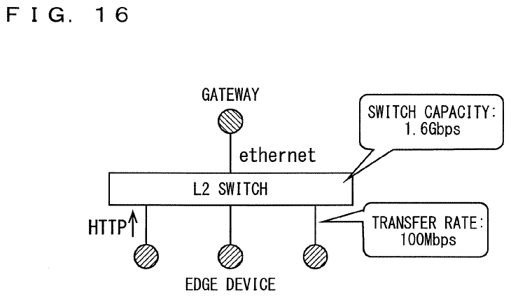

In the simulation according to the embodiment 1, the network simulation execution unit 14 can execute the simulation in consideration of a communication protocol and a connection configuration in communication made between any of the cloud server, the gateway, and the edge device to be targeted. A configuration assumed by the network in the network simulation execution unit 14 is defined to achieve such a simulation. Specifically, as illustrated in FIG. 16, arrangement of a communication apparatus such as a switch, for example, used in target network and connection of apparatuses are defined. A switch capacity and a performance value of a transfer rate of a communication apparatus and a communication protocol are defined as settings relating to a behavior of the network.

FIG. 16 illustrates the example of setting the network configuration in a graphical form on a graphical user interface (GUI), however, the GUI needs not be necessarily used for the setting. For example, a method of defining the network configuration may be an optional method such as performing description with a structured document such as an extensible markup language (XML) or a YAML ain′t markup language (YAML).

The communication protocol of the target network and the specification of the device are set as described above, thus a limitation condition of performance such as throughput and a communication speed in the network can be derived. The limitation condition is added to the evaluation function, thus the task allocation optimization unit 23 can derive the task allocation to which the limitation by the assumed network configuration is added.

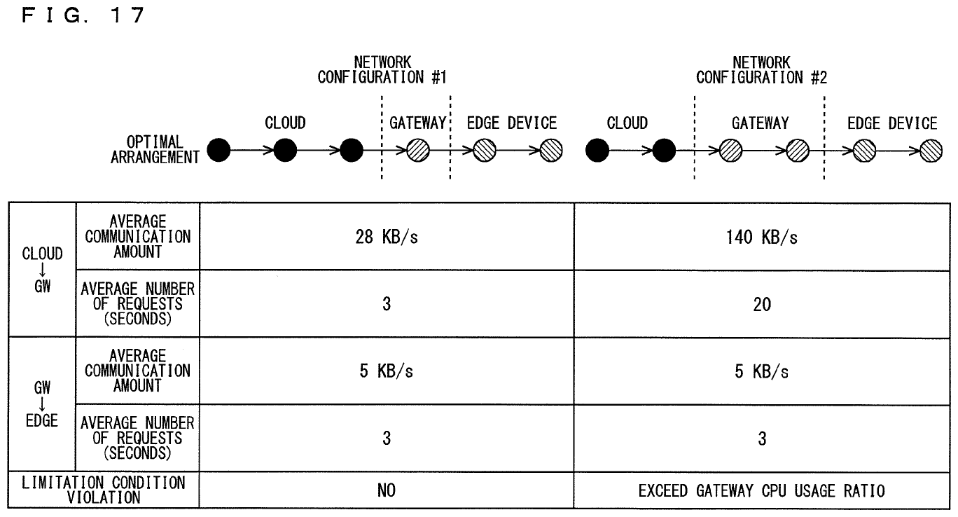

It is also assumed that a tendency of a communication traffic changes depending on a difference of the network configuration. As illustrated in FIG. 17, the output unit 25 can also compare contents of the non-functional requirement metrics before conversion 33, the non-functional requirement metrics after conversion 34, and the task allocation information 36 and display the contents thereof for the plurality of network configurations. In this manner, a tendency of a behavior of an IoT system and an optimal function arrangement result are compared, thus such a configuration assists a developer to select an appropriate network configuration. FIG. 17 illustrates an output example in a case of displaying the comparison result on a screen, thus does not limit adoption of the other output system such as contents of output items and file output, for example.

The definition of the network configuration described in the embodiment 3 is not necessary, however, a method of simply describing the network limitation may be adopted as illustrated in FIG. 9 in the embodiment 1.

### <Hardware Configuration>

Each function of the cloud server simulation execution unit 11, the gateway simulation execution unit 12, the edge device simulation execution unit 13, the network simulation execution unit 14, the allocation task execution unit 15, the metrics extraction unit 21, the metrics conversion unit 22, the task allocation optimization unit 23, the simulation execution controller 24, and the output unit 25 in the task allocation apparatus described in the embodiment 1 is achieved by a processing circuit. That is to say, a task allocation apparatus includes a processing circuit for: simulating an operation of a cloud; simulating an operation of a gateway; simulating an operation of an edge device; simulating an operation of network; allocating a task divided in accordance with contents of the task allocation information 36 to each of the cloud server simulation execution unit 11, the gateway simulation execution unit 12, and the edge device simulation execution unit 13; extracting the non-functional requirement metrics before conversion 33 from the simulation execution log 31; converting the non-functional requirement metrics before conversion 33 into the non-functional requirement metrics after conversion 34; evaluating validity of a current task allocation based on the non-functional requirement metrics before conversion 33 and the non-functional requirement metrics after conversion 34; controlling execution of the simulation in the simulation execution unit 10; and outputting task allocation information. The processing circuit may be dedicated hardware or a processor (also referred to as a CPU, a central processor, a processing device, an arithmetic device, a microprocessor, a microcomputer, or a digital signal processor (DSP)) executing a program stored in a memory.

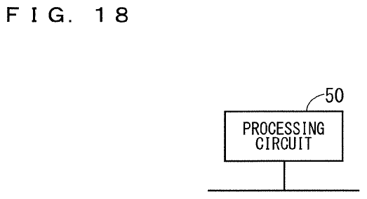

When the processing circuit is the dedicated hardware, a single circuit, a complex circuit, a programmed processor, a parallel-programmed processor, an application specific integrated circuit (ASIC), a field-programmable gate array (FPGA), or a combination of them, for example, falls under a processing circuit 50 as illustrated in FIG. 18. Each function of the cloud server simulation execution unit 11, the gateway simulation execution unit 12, the edge device simulation execution unit 13, the network simulation execution unit 14, the allocation task execution unit 15, the metrics extraction unit 21, the metrics conversion unit 22, the task allocation optimization unit 23, the simulation execution controller 24, and the output unit 25 may be achieved by the processing circuit 50, and each function may be collectively achieved by one processing circuit 50.

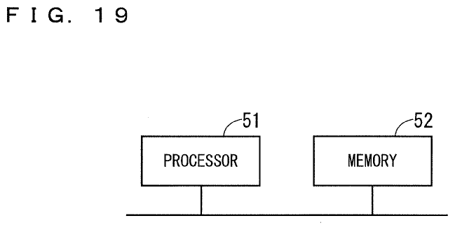

When the processing circuit 50 is a processor 51 illustrated in FIG. 19, each function of the cloud server simulation execution unit 11, the gateway simulation execution unit 12, the edge device simulation execution unit 13, the network simulation execution unit 14, the allocation task execution unit 15, the metrics extraction unit 21, the metrics conversion unit 22, the task allocation optimization unit 23, the simulation execution controller 24, and the output unit 25 is achieved by software, firmware, or a combination of software and firmware. The software or the firmware is described as a program and is stored in a memory 52. The processor 51 reads out and executes a program stored in the memory 52, thereby achieving each function. That is to say, the task allocation apparatus includes the memory 52 for storing programs resultingly executing steps of: simulating an operation of a cloud; simulating an operation of a gateway; simulating an operation of an edge device; simulating an operation of network; allocating a task divided in accordance with contents of the task allocation information 36 to each of the cloud server simulation execution unit 11, the gateway simulation execution unit 12, and the edge device simulation execution unit 13; extracting the non-functional requirement metrics before conversion 33 from the simulation execution log 31; converting the non-functional requirement metrics before conversion 33 into the non-functional requirement metrics after conversion 34; evaluating validity of a current task allocation based on the non-functional requirement metrics before conversion 33 and the non-functional requirement metrics after conversion 34; controlling execution of the simulation in the simulation execution unit 10; and outputting task allocation information. These programs are deemed to make a computer execute a procedure or a method of the cloud server simulation execution unit 11, the gateway simulation execution unit 12, the edge device simulation execution unit 13, the network simulation execution unit 14, the allocation task execution unit 15, the metrics extraction unit 21, the metrics conversion unit 22, the task allocation optimization unit 23, the simulation execution controller 24, and the output unit 25. Herein, a memory may be a non-volatile or volatile semiconductor memory such as a random access memory (RAM), a read only memory (ROM), a flash memory, an erasable programmable read only memory (EPROM), and an electrically erasable programmable read only memory (EEPROM), or, a magnetic disc, a flexible disc, an optical disc, a compact disc, a digital versatile disc (DVD), or any storage medium which is to be used in the future.

It is applicable that some function of each function of the cloud server simulation execution unit 11, the gateway simulation execution unit 12, the edge device simulation execution unit 13, the network simulation execution unit 14, the allocation task execution unit 15, the metrics extraction unit 21, the metrics conversion unit 22, the task allocation optimization unit 23, the simulation execution controller 24, and the output unit 25 is achieved by dedicated hardware and the other function thereof is achieved by software or firmware.

As described above, the processing circuit can achieve each function described above by the hardware, the software, the firmware, or the combination of them.

Described above is the hardware configuration of the task allocation apparatus described in the embodiment 1, however, the same applies to the hardware configuration of the task allocation apparatus described in the embodiments 2 and 3.

Each embodiment can be arbitrarily combined, or each embodiment can be appropriately varied or omitted within the scope of the invention.

Although the present disclosure is described in detail, the foregoing description is in all aspects illustrative and does not restrict the disclosure. It is therefore understood that numerous modification examples can be devised.

### EXPLANATION OF REFERENCE SIGNS

10 simulation execution unit, 11 cloud server simulation execution unit, 12 gateway simulation execution unit, 13 edge device simulation execution unit, 14 network simulation execution unit, 15 allocation task execution unit, 21 metrics extraction unit, 22 metrics conversion unit, 23 task allocation optimization unit, 24 simulation execution controller, 25 output unit, 31 simulation execution log, 32 system specification information, 33 non-functional requirement metrics, 34 non-functional requirement metrics, 35 evaluation weight value, 36 task allocation information, 40 task allocation history, 50 processing circuit, 51 processor, 52 memory.

1. A task allocation apparatus, comprising:
a processor to execute a program, and
a memory to store the program which, when executed by the processor, performs processes of,
simulating a cooperation operation between at least a cloud server and an edge device;
extracting simulation environment metrics as an index for evaluating a non-functional requirement in the cooperation operation from an execution log as the execution result of the simulation execution unit; and
deriving at least one allocation of a task executing the cooperation operation based on the simulation environment metrics which have been extracted, wherein
the execution log includes a monitoring log of a resource usage amount in each of at least the cloud server and the edge device, and
the simulation environment metrics include a transition of the resource usage amount in at least the cloud server and the edge device extracted from the monitoring log.

2. The task allocation apparatus according to claim 1, wherein the simulation of the cooperation operation includes simulating an operation of the cloud server, simulating an operation of the edge device, simulating an operation of a gateway, and simulating an operation of network, and
at least two of the simulation of the operation of the cloud server, the simulation of the operation of the edge device, the simulation of the operation of the gateway, and the simulation of the operation of network simulate the cooperation operation.

3. The task allocation apparatus according to claim 1, further comprising
converting the simulation environment metrics which have been extracted into real environment metrics assumed when the cooperation operation is actually executed based on system specification information including specification information of each of a simulation apparatus simulating the cooperation operation, the cloud server, and the edge device.

4. The task allocation apparatus according to claim 1, wherein
the derivation of the allocation of the task includes deriving the allocation based on the simulation environment metrics which have been extracted and an evaluation weight value for the non-functional requirement.

5. The task allocation apparatus according to claim 1, wherein
the derivation of the allocation of the task includes deriving the allocation for each of a plurality of evaluation functions.

6. The task allocation apparatus according to claim 3, wherein
the derivation of the allocation of the task includes deriving the allocation for each of a plurality of evaluation functions.

7. The task allocation apparatus according to claim 6, wherein
when there is a common condition in each of the evaluation functions, the derivation of the allocation of the task includes deriving the allocation for an execution result of this time based on a task allocation history in which the simulation environment metrics and the real environment metrics for a previous execution result and the allocation at a previous time are associated with each other.

8. The task allocation apparatus according to claim 1, further comprising
outputting the allocation which has been derived.

9. The task allocation apparatus according to claim 8, wherein
the derivation of the allocation of the task includes deriving the plurality of allocations, and
the output of the allocation includes outputting each of the allocations which has been derived.

10. The task allocation apparatus according to claim 5,
wherein
the output of the allocation includes outputting the allocation for each of the evaluation functions.

11. The task allocation apparatus according to claim 2, wherein
the derivation of the simulation environment metrics includes deriving a limitation condition of network targeted by the simulation of the operation of the network based on at least one network configuration which is previously defined.

12. The task allocation apparatus according to claim 11, wherein
the derivation of the allocation of the task includes deriving the allocation based on a limitation condition of the network.

13. The task allocation apparatus according to claim 11,
wherein
the output of the allocation includes outputting at least the simulation environment metrics and the allocation in a comparative manner for the plurality of network configurations.

14. A task allocation method, comprising:
simulating a cooperation operation between at least a cloud server and an edge device;
extracting simulation environment metrics as an index for evaluating a non-functional requirement in the cooperation operation from an execution log as an execution result; and
deriving an allocation of a task executing the cooperation operation based on the simulation environment metrics which is extracted, wherein
the execution log includes a monitoring log of a resource usage amount in each of at least the cloud server and the edge device, and
the simulation environment metrics include a transition of the resource usage amount in at least the cloud server and the edge device extracted from the monitoring log.
